(19) United States
(12) Patent Application Publication
(10) Pub. No.: US 2006/0240176 A1
(43) Pub. Date: Oct. 26, 2006

(54) Method for manufacturing confectionery, freeze drying method and freeze-dried confectionery

(75) Inventors: Keiichi Yamaguchi, Shibukawa-City (JP); Hironobu Tsujiguchi, Tokyo (JP); Hiroyuki Kamijo, Azumino-Shi (JP); Shunzo Oike, Azumino-Shi (JP)

Correspondence Address: Law Office of Townsend & Banta;c/o PortfolioIP, P.O. Box 52050, Minneapolis, MN, 55402, US

(73) Assignees: Gumma Rice Flour Milling Co., Ltd.; Ash Tsujiguchi Corporation

(21) Appl. No.: 11/391,514

(22) Filed: Mar. 28, 2006

(30) Foreign Application Priority Data
Apr. 26, 2005 (JP) JP2005-127554

(51) Int. Cl. A23G 3/00

(52) U.S. Cl. 426/660

(57) ABSTRACT

A method for freeze drying confectionary is provided, whereby a confectionary is provided that can be stored for long periods of time without deformation. Further, a confectionery is provided using cream comprising 28 to 33 parts by weight of cream having a milk fat content of 42% to 48%, 28 to 33 parts by weight of cream having a milk fat content of 32% to 38%, 28 to 33 parts by weight of vegetable-based cream, and 5 to 10 parts by weight of sugar. The confectionery is freeze dried by: freezing the confectionery; subsequently setting the drying pressure to 0.60 to 0.65 Torr; performing primary sublimation by drying at a temperature of 25° C. to 40° C., for 3 to 4 hours; subsequently performing secondary sublimation by drying at a temperature of 60° C. to 70° C. for 18 to 20 hours; and further performing tertiary sublimation by drying at a temperature of 35° C. to 45° C. for 1.5 to 4.5 hours.

### FIELD OF THE INVENTION

The present invention relates to technology for freeze-drying confectionery, and more specifically to cream combination ratios used when confectioneries containing cream, such as cakes, are freeze-dried. The present invention further relates to technology for improving freeze drying for confectionery in general, and to confectionery produced by freeze drying.

### BACKGROUND OF THE INVENTION

Technology for freeze drying confectionery such as ice cream is known in the art, for example as disclosed in JP-47-01901 1-B. However, with the technology disclosed in JP-47-019011-B, because ingredients were not specifically selected with a view to freeze drying same, there was a problem in that cracks formed during the freeze drying process. In order to solve this problem, an invention disclosed in JP-2003-199500-A describes the use of sweeteners comprising a sugar alcohol content of no less than 20 wt %.

Furthermore, while frozen cake has existed for many years, frozen cake comprises components such as sugar, carbohydrates and fresh fruits, and must therefore be stored at low temperatures. Furthermore, frozen cake readily deforms when melted. In addition, because the compositions described above could easily be contaminated, there is a risk of bacterial contamination, so that even short term storage is difficult, and long term storage impossible. Furthermore, because sugar products are viscous, they tend to be sticky, and the physical strength of the product was low, which was disadvantageous in terms of portability and transport.

Meanwhile, if one attempts to freeze-dry Western confectioneries, such as cakes, in which cream is used, because the cream portion contracts during freeze drying, there is a problem in that the shape of the confectionary is not maintained. Furthermore, there is a problem in that, in addition to the cream portion, the sponge cake portion contracts, so that the base sinks. Consequently, if such confectionary is freeze-dried by the same freeze drying methods as are employed for ready-made foods such as fixings for instant noodles, the yield is inferior, the texture of the confectionary becomes hard, the surface thereof becomes rough, and it is difficult to produce a salable product. In addition, in cases where a person wishes to keep confectionery that was exhibited in a cake show or the like as a souvenir, with conventional technology, the confectionary can only be displayed by way of storage in a refrigerated case for approximately 3 days, after which it is discarded.

Accordingly, an object of the present invention is to provide a method for freeze drying confectionery allowing for long-term storage, while maintaining the original shape of the confectionery. Another object of the present invention is to provide a novel confectionery produced by this freeze drying method. A further object of the present invention is to provide a combination ratio for ingredients in confectionery, particularly such as cakes in which cream is used, whereby it is possible limit the contraction of the cream, and thus to maintain the shape of the confectionary, even when this is freeze-dried. Yet another object of the present invention is to provide technology for decorating the aforementioned confectionary with chocolate.

### SUMMARY OF THE INVENTION

A first embodiment of the present invention provides a method for manufacturing confectionery comprising using cream comprising 28 to 33 parts by weight of cream having a milk fat content of 42% to 48%, 28 to 33 parts by weight of cream having a milk fat content of 32% to 38%, 28 to 33 parts by weight of vegetable-based cream, and 5 to 10 parts by weight of sugar, whereby it is possible to provide a confectionary using cream, in which there is little deformation when freeze dried.

A second embodiment of the present invention provides a method for freeze drying confectionery comprising the steps of: freezing the confectionery; subsequently setting the drying pressure to 0.60 to 0.65 Torr; performing primary sublimation by drying at a temperature of 25° C. to 40° C., for 3 to 4 hours; subsequently performing secondary sublimation by drying at a temperature of 60° C. to 70° C. for 18 to 20 hours; and further performing tertiary sublimation by drying for 1.5 to 4.5 hours at a temperature of 35° C. to 45° C., with which there is little deformation when confectionary is freeze dried, and with which the appeal of the confectionary can be maintained.

A third embodiment of the present invention provides a freeze-dried confectionery produced by freezing the confectionery; subsequently setting the drying pressure to 0.60 to 0.65 Torr; performing primary sublimation by drying at a temperature of 25° C. to 40° C., for 3 to 4 hours; subsequently performing secondary sublimation by drying for 18 to 20 hours at a temperature of 60° C. to 70° C.; and further performing tertiary sublimation by drying for 1.5 to 4.5 hours at a temperature of 35° C. to 45° C., which is convenient in terms of transport and allows for long-term storage.

A fourth embodiment of the present invention provides a confectionery produced by freeze drying, by the method recited in the second embodiment of the present invention, the confectionery prepared according to the method recited in the first embodiment of the present invention, which allows for long term storage of the confectionary as a souvenir, in cases such as, for example, those in which the confectionary was exhibited in a cake show and won a prize.

A fifth embodiment of the present invention provides a method for manufacturing a freeze-dried confectionery, wherein chocolate that has been melted at a temperature of 40° C. to 55° C., subsequently cooled to 25° C. to 30° C., and then heated to 30° C. to 35° C. is applied to the confectionery recited in the forth aspect of the present invention,

By using whipped cream produced by beating creams that have been combined at ratios according to the present invention, it is possible to limit the contraction of the cream portion of the confectionery when this is freeze-dried. Furthermore, by using the freeze drying method according to the present invention, freeze drying can be performed with limited deformation of the sponge portion of the confectionary, so that there is little deformation of the overall confectionery and the confectionary can be stored for long periods of time. Consequently, souvenir cakes that have been exhibited at cake shows and the like can be stored for long periods of time without loosing their shapes.

Furthermore, the present invention provides a freeze drying method which does not affect the components of the confectionery, because only the water content of the confectionery is sublimated. The present invention thus provides a delicious freeze-dried confectionery having a novel texture without degrading the original flavor or color of the confectionery.

Because the water content of the confectionary of the present invention is 3% to 5%, which is lower than in conventional frozen cakes, there is no risk of bacterial proliferation, and thus safe. Further, because the confectionary is not viscous, it is convenient in terms of portability and transport. And, because the storage characteristics of the confectionary are good, it is useful as a food to be served on airplanes, as a nonperishable food, or as a food for use in space.

Furthermore, in the past, if chocolate was applied to freeze-dried cream confectioneries, there was a problem in that, depending on the type and temperature of the chocolate, the cream portion of the confectionary would melt, which led to deformation of the product, meaning that such products could not be marketed. However, if chocolate is applied to the freeze-dried cream confectionery according to the present invention, it is possible to provide a well finished freeze-dried confectionery.

### DETAILED DESCRIPTION OF THE INVENTION

In terms of the ratio according to the present invention at which creams are combined so as to limit deformation of the cream portions of confectionaries, a cream can be used that comprises 28 to 33 parts by weight of cream having a milk fat content of 42% to 48%; 28 to 33 parts by weight of cream having a milk fat content of 32% to 38%; 28 to 33 parts by weight of vegetable-based cream; and 5 to 10 parts by weight of sugar. More preferably, identical quantities of three types of cream, being cream having a milk fat content of 45%, cream having a milk fat content of 35%, and vegetable-based cream are combined, and 7 to 8 parts by weight of sugar, with respect to the total quantity of cream, is added, and this mixture is whipped.

The characteristics of creams depend on the concentration of milk fat therein. For example, cream having a milk fat content of 47% is thick, does not readily separate, and is suitable for decoration. A characteristic thereof is that, if used with sour or strong flavors such as raspberry, passion fruit, or coffee, the result is a mellow flavor. Another characteristic is that, if used in a creme patissiere (in custard cream), there is a good balance between the egg flavor and the richness of the milk.

A characteristic of cream having a 40% milk fat content is that, when used in gelatin cheesecakes, creme brulee and the like, it imparts a rich milk flavor, while bringing out the flavors of the other ingredients. This cream also produces a fine, stable and visually attractive whipped cream. Cream containing 35% milk fat produces whipped cream having a high air content, which produces a light texture, and when mixed into mousses or Bavarian cream, brings out fruit flavors. Thus, generally, a 5% difference in milk fat content has a large effect on the resulting product, but the present invention uses a whipped combination of three types of creams, which is to say heavy and light dairy creams and a vegetable-based cream, so as to limit the deformation of the confectionery when freeze-dried.

Note that, as described above, in the present invention, it is preferable to use cream having a milk fat content of 45%, so as to provide a full, rich and creamy flavor, cream having a milk fat content of 35%, so as to provide a light texture, resulting from the high air content thereof, and highly stable vegetable-based cream. Note that, any vegetable-based cream having a fat content of 10% to 50% can be used.

Next, description is given with reference to the sugar. It is preferable that granulated sugar be used in the method and confectionary of the present invention. Note that any sugar that is conventionally used for confectionery, such as white superior soft sugar, powdered sugar, maple sugar, starch syrup and the like can be used, but sugar in granular form is preferred.

Next, the freeze drying method according to the present invention will be described. After freezing the confectionery, freeze drying is performed by way of freezing the confectionery; subsequently setting the drying pressure to 0.60 to 0.65 Torr; performing primary sublimation by drying the confectionary at a temperature of 25° C. to 40° C., for 3 to 4 hours; subsequently performing secondary sublimation by drying the confectionary at a temperature of 60° C. to 70° C. for 18 to 20 hours; and further performing tertiary sublimation by drying the confectionary at a temperature of 35° C. to 45° C. for 1.5 to 4.5 hours.

Optimal drying conditions are explained by way of comparison with a freeze drying method for conventional dried food products, with reference to Table 1. First, the vacuum is usually set to approximately 0.54 Torr, but in the present invention it is preferable to begin drying at approximately 0.63 Torr. Furthermore, drying is usually performed in three stages at an initial low temperature (approximately 2 hours at 40° C.), an intermediate temperature (approximately 27 hours at 80° C.), and a final temperature (approximately 5 hours at approximately 50° C.), so as to be completed in approximately 30 hours in total. However, it is preferable that the dry heating conditions for the confectionery be such that, for the primary sublimation, initial sublimation is performed for 3 to 4 hours while maintaining the temperature at 28° C. to 36° C., for the secondary sublimation, the temperature is increased to 65° C. and intermediate drying is performed for 18 hours, and lastly for tertiary sublimation, the temperature is lowered to 40° C. and drying is performed for 1.5 to 4.5 hours, so that drying is completed in a total of less than 27 hours.

TABLE 1
Comparison of conventional freeze drying conditions and freeze
drying conditions according to the present invention

| | | | Confectionary |
|---|---|---|---|
| | | Conventional Dried | According to the |
| | | Food Product | Present Invention |
| Vacuum (Torr) | | 0.54 | 0.63 |
| Primary | Time (hrs) | 1.5 to 2.0 | 3.0 to 4.0 |
| Sublimation | Temp. (° C.) | 40 | 28 to 36 |
| Secondary | Time (hrs) | 27 | 18 to 20 |
| Sublimation | Temp. (° C.) | 80 | 65 |
| Tertiary | Time (hrs) | 3.0 to 7.0 | 1.5 to 4.5 |
| Sublimation | Temp. (° C.) | 40 to 60 | 40 |

Deformation of the confectionary can be limited by the combined effects of limiting deformation of the sponge cake portion by freeze drying according to the present method described above, and by using creams combined at the ratios described above. Note that the freeze drying method of the present invention can also be applied to confectionery that does not use cream, such as tarts, muffins, cream puffs, madeleines, doughnuts and the like, and can be applied, not only to Western confectionery, but also to Japanese-style confectionery, which uses sweet bean paste, rice cake, rice flour and the like, so as to provide delicious confectionery that maintains the shape, color and aroma of the confectionery before freeze drying.

The texture of the confectionery produced by the drying method described above is similar to that of baked confectionery, but differs from conventional confectionery in that the sensation on the palate is light, soft and smooth. Furthermore, if the freeze drying method described above is used for confectionery in which cream is used, it is possible to provide a freeze-dried confectionery having a novel texture in which the color, aroma and flavor of the cream and the toppings or fillings is unchanged.

By applying chocolate which has been tempered by melting at 40° C. to 55° C., then cooling to 25° C. to 30° C., and then heating to 30° C. to 35° C., to the confectionery produced in the manner described above, it is possible to provide a confectionery that maintains its shape without the freeze-dried confectionery being melted by the chocolate.

That is to say, by way of the method of the present invention described above, tempering is performed, which is a process wherein a crystal nucleus for a stable crystal is formed, so that the cocoa butter, which has many crystal forms, is hardened in a crystalline manner with a stable crystal form. If the tempering is insufficient, a phenomena known as bloom occurs, in which a white powder appears on the chocolate as a result of temperature changes, which reduces the value of the product. Because the smoothness of the chocolate when eaten is determined by alignment of the cocoa butter, this process is indispensable for high quality. When chocolate is applied to the freeze-dried confectionery, it is likewise preferable that the tempering described above be performed.

### PREPARATION EXAMPLES

### Example 1

One example of the cream combination ratio for limiting deformation of cream portions according to the present invention is described as follows:

300 g of cream having a milk fat content of 45%, 300 g of cream having a milk fat content of 35%, 300 g of vegetable-based cream and 70 g of granulated sugar were whipped in a mixer with ice cooling.

After using the cream produced in this manner to prepare cakes, the cakes were freeze-dried. First, after freezing the confectionery (cakes), the drying pressure was set to 0.63 Torr. For the primary sublimation, initial sublimation was performed by drying the confectionery with the temperature maintained at 28 to 36° C. for 3 to 4 hours. Next, for the secondary sublimation, intermediate drying was performed thereon by raising the temperature to 65° C. and drying for 18 to 20 hours. Finally, for tertiary sublimation, final drying was performed by lowering the temperature to 40° C., and drying for 1.5 to 4.5 hours. In a preferred mode, final drying was performed for 3 hours.

With the method of manufacturing of the present invention, at a ratio at which the creams are combined as described above, not only was the deformation of the cream portions of the cakes limited, but by employing the freeze drying process described above, in addition to limiting the deformation of the cream portions, it was possible to limit the deformation of the sponge cake portion of the cakes, so that there was little deformation of the overall confectionery.

### Example 2

Next, an example relating to chocolate tempering is described as follows:

Coating of a confectionery of the present invention was performed with couverture sweet chocolate, having a cacao content of no less than 50%. In particular, the couverture sweet chocolate was slowly melted by heating to 50° C. in a hot water bath, slowly cooled to 27° C., and then heated to 33° C., so as to align the cocoa butter. This melted chocolate was then applied to the freeze-dried confectionery of the present invention.

Because there was no milk fat content in the sweet chocolate, the sweet chocolate could be heated to 50° C. The chocolate must be thoroughly melted so as to completely and evenly distribute the cocoa butter, sugar, and cacao mass which are base materials. Note that the process must be performed with care because, at greater than 50° C., the mixture may suddenly burn. Crystals in the sweet chocolate could not be seen when it was heated to 50° C., but when cooled to 27° C., type IV crystals formed. Stable type V crystals were formed by heating to 33° C.

By tempering in this manner, it was possible to produce chocolate that was hard at room temperature, had quick melt characteristics, and provided a smooth feeling on the tongue. By decorating the freeze-dried confectionery of the present invention with this chocolate, confectionary having increased product value was produced.

### Example 3

Next, for chocolate comprising milk fat, such as milk chocolate or white chocolate, and for chocolate having a cocoa content of approximately 35%, it is preferable that tempering be performed at temperatures of 2° C. to 3° C. lower than those described in Example 2 above. Thus, the chocolate was slowly melted by heating to 45° C. in a hot water bath. Next, the chocolate was cooled to 26° C. in an ice bath. The temperature was again raised to 28° C., so as to align the cocoa butter. The melted chocolate was then applied to the freeze-dried confectionery of the present invention.

If chocolates containing milk fat are heated to more than 50° C., the cocoa alignment becomes irregular, such that the chocolate does not solidify or does not thoroughly solidify, and irregularities are formed on the surface thereof which lowers the product value. Accordingly, it is preferable that tempering be performed at 2° C. to 3° C. lower than tempering in the case of the sweet chocolate described in Embodiment 2.

By tempering in this manner, it was possible to produce chocolate that was hard at room temperature, had quick melt characteristics, and produced a smooth feeling on the tongue. By decorating the freeze-dried confectionery of the present invention with this chocolate, confectionary having increased product value was produced.

1. A freeze dried confectionery comprising:
28 to 33 parts by weight of cream having a milk fat content of 42% to 48%,
28 to 33 parts by weight of cream having a milk fat content of 32% to 38%,
28 to 33 parts by weight of vegetable-based cream, and
5 to 10 parts by weight of sugar.

2. A method for freeze drying confectionery comprising the steps of:
freezing the confectionery;
subsequently setting the drying pressure to 0.60 to 0.65 Torr;
performing primary sublimation by drying the confectionery at a temperature of 25° C. to 40° C. for 3 to 4 hours;
subsequently performing secondary sublimation by drying at a temperature of 60 to 70° C. for 18 to 20 hours; and
then performing tertiary sublimation by drying the confectionery at a temperature of 35 to 45° C. for 1.5 to 4.5 hours.

3. A freeze-dried confectionery produced by a process comprising:
freezing the confectionery;
subsequently setting the drying pressure to 0.60 to 0.65 Torr;
performing primary sublimation by drying the confectionery at a temperature of 25° C. to 40° C., for 3 to 4 hours;
subsequently performing secondary sublimation by drying the confectionery at a temperature of 60 to 70° C. for 18 to 20 hours; and
further performing tertiary sublimation by drying the confectionery at a temperature of 35 to 45° C. for 1.5 to 4.5 hours.

4. (canceled)

5. A method for manufacturing a freeze-dried confectionery, wherein chocolate that has been melted at a temperature of 40° C. to 55° C., subsequently cooled to 25° C. to 30° C., and then heated to 30° C. to 35° C. is applied to the confectionery recited in claim 6.
Please add new claim 6 as follows:

6. The freeze dried confectionery of claim 1, produced by:
freezing the confectionery;
subsequently setting the drying pressure to 0.60 to 0.65 Torr;
performing primary sublimation by drying the confectionery at a temperature of 25° C. to 40° C. for 3 to 4 hours;
subsequently performing secondary sublimation by drying at a temperature of 60 to 70° C. for 18 to 20 hours; and
then performing tertiary sublimation by drying the confectionery at a temperature of 35 to 45° C. for 1.5 to 4.5 hours.
